(19) United States
(12) Patent Application Publication
(10) Pub. No.: US 2016/0131828 A1
(43) Pub. Date: May 12, 2016

(54) ILLUMINATION DEVICE, DISPLAY DEVICE, AND TV RECEIVER

(71) Applicant: SHARP KABUSHIKI KAISHA, Osaka (JP)

(72) Inventor: Akira GOTOU, Osaka (JP)

(73) Assignee: Sharp Kabushiki Kaisha, Osaka (JP)

(21) Appl. No.: 14/896,739

(22) PCT Filed: Feb. 25, 2014
(86) PCT No.: PCT/JP2014/054433

§ 371 Date: Dec. 8, 2015

(30) Foreign Application Priority Data
Jun. 12, 2013 (JP) 2013-123479

(51) Int. Cl. F21V 8/00; H04N 9/31

(52) U.S. Cl. CPC G02B 6/0088; G02B 6/009; H04N 9/3141

(57) ABSTRACT

A backlight device of the present invention includes: a light guide plate having light-entering faces on opposing end faces thereof and a light-exiting surface on the front surface thereof; LEDs arranged selectively along one section of the light-entering faces of the light guide plate; a front cabinet arranged on a side of the light-exiting surface of the light guide plate and having a frame-like shape along a periphery of the light guide plate; and a rear cabinet arranged on a side of the light guide plate opposite to the front cabinet such that the rear cabinet and the front cabinet sandwich the light guide plate therebetween. The rear cabinet has a fixed portion that is disposed facing a section of the light-entering face that does not correspond to the one section where the LEDs are selectively arranged, and the fixed portion is fixed to the front cabinet.

### TECHNICAL FIELD

The present invention relates to an illumination device, a display device, and a TV receiver.

### BACKGROUND ART

A liquid crystal display device such as a liquid crystal TV uses a liquid crystal panel as a display panel that displays an image and a backlight device that provides lighting for the liquid crystal panel, for example. In this type of a liquid crystal display device, for design reasons or the like, there can be demand for reducing the size of the frame region of the backlight device, or in other words narrowing the frame region. Patent Document 1 discloses a liquid crystal display device that has a narrowed frame region, for example.

### RELATED ART DOCUMENT

### Patent Document

Patent Document 1: Japanese Patent Application Laid-Open Publication No. 2010-210938

### Problems to be Solved by the Invention

In a configuration that is equipped with an edge-lit type backlight device like the liquid crystal display device of Patent Document 1 described above, a light guide plate used to guide the light emitted from light sources toward the liquid crystal panel can be disposed inside a case. In this type of a backlight device, when a case is composed of a plurality of members that sandwich the polarizing plate, space for providing a fixing structure used to fix these members in the outer region of the light guide plate becomes necessary. However, when an attempt was made to provide such a fixing structure on the outer side of the light sources in the outer region of the light guide plate, large space became necessary in the frame region of the backlight device, which made the attempt to narrow the frame region difficult. As a result, the plurality of members that compose the case could not be fixed in a favorable manner, which raised a concern that the strength of the backlight device might be reduced.

### SUMMARY OF THE INVENTION

The technology disclosed in the present specification was made in view of the above-mentioned problems. The aim of the present specification is to provide a technology that can prevent or restrain the reduction in the strength of the backlight device while attempting to narrow the frame region.

### Means for Solving the Problems

A technology disclosed in the present specification relates to an illumination device, including: a light guide plate having a light-entering face on at least one end face thereof and a light-exiting surface on one surface thereof; a light source arranged selectively along one section of an end face that is the light-entering face of the light guide plate; a frame member arranged on a side of the light-exiting surface of the light guide plate, the frame member having a frame-like shape along a periphery of the light guide plate; and a sandwiching member arranged such that the sandwiching member and the frame member sandwich the light guide plate therebetween, the sandwiching member having a fixed portion that is disposed outside a section of an end face that is the light-entering face that does not correspond to the one section, the fixed portion being fixed to the frame member.

A plurality of members that sandwich the light guide plate in an edge-lit type backlight device are fixed to each other by fixing members or the like. In addition to the light sources, a supporting member such as a light source substrate is provided on the part of the region, located on the outer side of the light-entering face of the light guide plate, where the light sources are disposed. Here, suppose that a fixing structure used to fix the plurality of members for sandwiching the light guide plate therebetween is provided on the outer side of the supporting member. In this case, if the width in the direction orthogonal to the light-entering face where the fixing structure is provided is widened, narrowing the frame region of the backlight device becomes difficult. On the other hand, suppose that the width in the direction orthogonal to the light-entering face of the portion where the fixing structure is provided is made smaller in order to narrow the frame region of the backlight device. In that case, the fixing members or the like used to fix a plurality of members, which sandwich the light guide plate therebetween, to that portion cannot be provided, and fixing the plurality of members in a favorable manner becomes difficult. This raises a concern that the strength of the backlight device might be reduced.

In the illumination device described above, the plurality of members, or in other words the frame member and the sandwiching member, were arranged sandwiching the light guide plate. In this configuration, the frame member and the sandwiching member are fixed at the fixed portion. The part of the region, located on the outer side of the light-entering face of the light guide plate, where the light sources are not disposed is the fixed portion described above. In this configuration, the space in the fixed portion that becomes unoccupied because the light sources or the like are not disposed can be used as the space for disposing the fixing members or the like. Thus, even when the orthogonal direction width of the fixed portion is made wider, the frame region of the illumination device can be made narrower. As a result, the frame member and the sandwiching member (holding member) will be fixed in a favorable manner at least at the fixed portion, thereby preventing or restraining the reduction in the strength of the illumination device. The illumination described above can prevent or restrain the reduction in the strength thereof while attempting to narrow the frame region.

The light guide plate may have a quadrangular shape, and have the light-entering face on each of the opposing end faces thereof.

In this configuration, the brightness of the display device can be improved because light is allowed to enter from both of the end faces that form the opposing sides of the light guide plate. Also, in the sandwiching member, the fixed portion is provided on each of the end faces that form the opposing sides of the light guide plate. Thus, the sandwiching member can be fixed to the frame member in a favorable manner.

In a pair of the light-entering faces that form the opposing end faces, the light source arranged along one of the light-entering faces may not be arranged across from the light source arranged along a side of other the light-entering face in a direction orthogonal to the light-entering faces.

In this configuration, a plurality of the fixed portions are provided such that they do not face each other when viewing the light guide plate in a plan view, and the plurality of the fixed portions become distributed equally on the sandwiching member. Thus, the sandwiching member can be fixed to the frame member in a favorable manner.

The illumination device may further include: a screw that fixes the sandwiching member to the frame member at the fixed portion by penetrating through a screw hole provided in the sandwiching member and penetrating into the frame member, wherein the sandwiching member has a locking part in an area thereof that is opposite to the end face that is the light-entering face and that sandwiches the light source therebetween, the locking part locking the sandwiching member to the frame member.

This configuration allows the narrowing of the frame region of the illumination device while securing a large space for the orthogonal direction width in the fixed portion in order to dispose the screw in the fixed portion. Thus, using the screw, the sandwiching member can be firmly fixed to the frame member. Furthermore, the locking structure of the locking part has a narrower orthogonal direction width compared to that of the fixed portion in which the screw or the like is disposed. Thus, the sandwiching member can be locked to the frame member at the locking part while narrowing the frame region of the illumination device. As described above, the configuration described above can further prevent or restrain the reduction in the strength of the illumination device by locking the sandwiching member to the frame member at a portion other than the fixed portion while narrowing the frame region of the illumination device.

The sandwiching member may lock to the frame member by engaging with the frame member at the locking part

This configuration allows the sandwiching member to be locked to the frame member without using the locking member or the like at the locking part, thereby reducing material cost. The frame region of the illumination device can be further narrowed because the orthogonal direction width of the locking structure of the locking part can be made smaller compared to when using the locking member or the like.

The sandwiching member may have an abutting portion in an area thereof that is opposite to the end face that is the light-entering face and that sandwiches the light source therebetween, the abutting portion abutting the frame member without being fixed thereto.

In this configuration, the orthogonal direction width of the part where the locking structure or the like is provided can be made narrower compared to when providing the locking structure or the like in the region of the sandwiching member across the light sources and opposite from the portion of the end face defined as the light-entering face. As a result, the frame region of the illumination device can be made even narrower.

The frame member and the sandwiching member may form an exterior of the illumination device.

In the configuration in which a pair of the exterior members that form the exterior of the illumination device are fixed to each other, the frame region of the illumination device can be narrowed while preventing or restraining the reduction in the strength of the illumination device.

All the end faces of the light guide plate may be the light-entering faces.

In this configuration, light enters from each of the end faces of the light guide plate. Thus, the brightness in the display surface of the illumination device can be increased.

The technology disclosed in the present specification can be expressed as a display device including: the illumination device; and a display panel that performs display using light from the illumination device. A display device, in which the display panel is a liquid crystal panel that uses liquid crystal, is also novel and useful. A television receiver that includes the display device is also novel and useful.

### Effects of the Invention

In the technology described in the present specification, a configuration that enables the light sources to be arranged at any position can prevent or restrain the reduction in the strength of the backlight device while attempting to narrow the frame region.

### BRIEF DESCRIPTION OF THE DRAWINGS

FIG. 1 is an exploded perspective view of a television receiver according to Embodiment 1.

FIG. 2 is a cross-sectional view showing a cross-section of a liquid crystal display device cut along the long side direction thereof.

FIG. 3 is a plan view of a rear cabinet and a chassis seen from the front side.

FIG. 4 is a plan view of the rear cabinet housing a light guide plate and LED units and the chassis seen from the front side.

FIG. 5 is an enlarged cross-sectional view of an area around the LED unit in the liquid crystal display device.

FIG. 6 is an enlarged cross-sectional view of an area around a fixed portion in the liquid crystal display device.

FIG. 7 is an enlarged cross-sectional view of an area around the LED unit in a liquid crystal display device according to Modification Example 1 of Embodiment 1.

FIG. 8 is an enlarged cross-sectional view of an area around the LED unit in a liquid crystal display device according to Modification Example 2 of Embodiment 1.

FIG. 9 is a plan view of a rear cabinet housing a light guide plate and LED units and a chassis seen from the front side in Embodiment 2.

FIG. 10 is a plan view of a rear cabinet housing a light guide plate and LED units and a chassis seen from the front side in Embodiment 3.

FIG. 11 is a plan view of a rear cabinet housing a light guide plate and LED units and a chassis seen from the front side in Embodiment 4.

FIG. 12 is a cross-sectional view showing a cross-section of a liquid crystal display device of Embodiment 5 cut along the short side direction thereof.

### DETAILED DESCRIPTION OF EMBODIMENTS

### Embodiment 1

Embodiment 1 is described below with reference to the drawings. In the present embodiment, a television receiver TV is described as an example. Each of the drawings indicates an X axis, a Y axis, and a Z axis in a portion of the drawings, and each of the axes indicates the same direction for the respective drawings. The Y axis direction corresponds to the vertical direction, and the X axis direction corresponds to the horizontal direction. Unless otherwise noted, “up” and “down” in the description are based on the vertical direction, and in cross-sectional views, the upper side of the figure is the front side, and the lower side is the rear side.

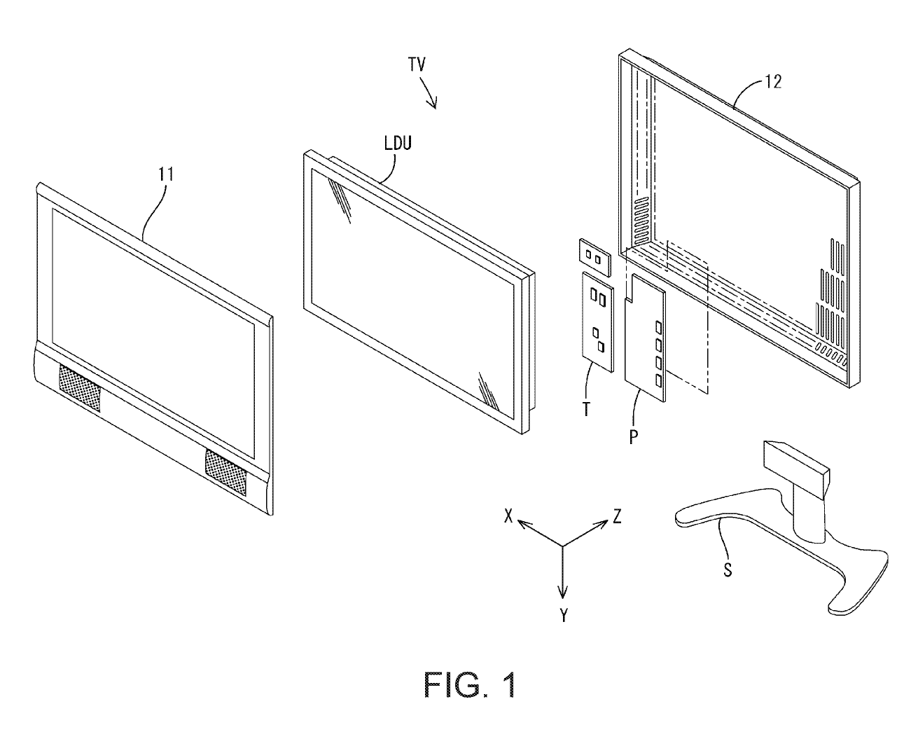

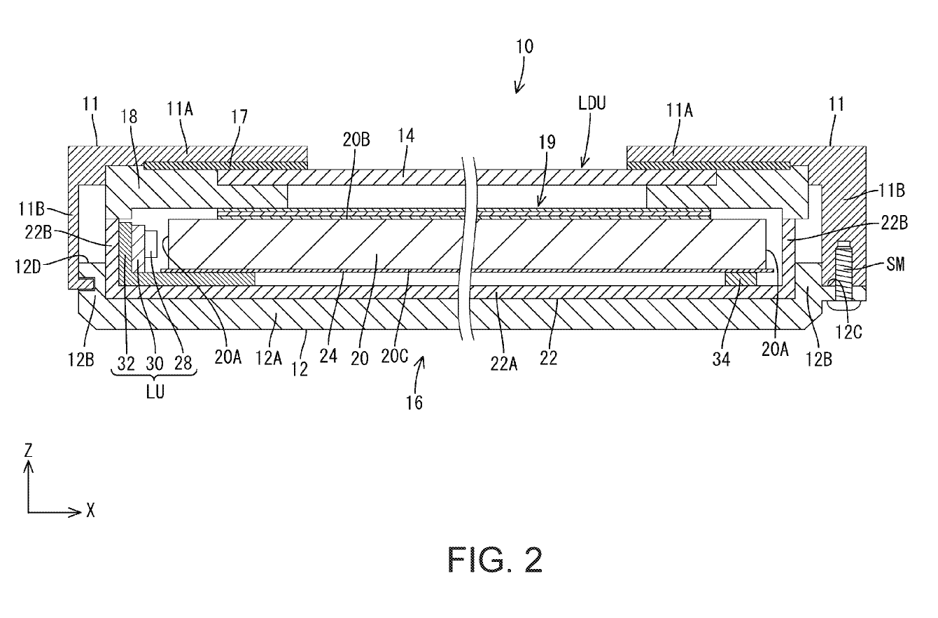

As shown in FIGS. 1 and 2, a television receiver TV according to the present embodiment includes a liquid crystal display device 10 (one example of a display device), a power source P, a tuner T, and a stand S. The liquid crystal display device 10 includes and is configured by a liquid crystal panel 14 and a backlight device (an example of an illumination device) 16 that provides light for the liquid crystal panel 14. Each of the various constituting components that constitute the backlight device 16 is housed in a pair of cabinets 11 and 12, which are exterior members that form the exterior of the backlight device 16. The portion of the backlight device 16 excluding the pair of cabinets 11 and 12 is called a liquid crystal display unit LDU (see FIG. 1).

In the liquid crystal panel 14, a pair of transparent (having a high degree of light transmission characteristics) glass substrates are bonded together with a prescribed gap therebetween, and a liquid crystal layer (not shown) is sealed between the glass substrates. One of the glass substrates is provided with switching elements (TFTs, for example) connected to source lines and gate lines that intersect each other, pixel electrodes connected to the switching elements, an alignment film, and the like. The other glass substrate is provided with color filters including respective colored portions of R (red), G (green), B (blue), and the like, which are in a prescribed arrangement, an opposite electrode, an alignment film, and the like. Of these, the source lines, the gate lines, the opposite electrode, and the like are supplied with image data and various control signals from a driver circuit substrate (not shown) necessary for displaying an image. Polarizing plates (not shown) are disposed on the respective outer sides of the glass substrates. In the liquid crystal display device 10, the liquid crystal panel 14 is assembled with the display surface capable of displaying an image facing the front side.

Next, each constituting component of the backlight device 16 will be described. Of the pair of the cabinets 11 and 12 that form the backlight device 16, the cabinet that is exposed to the front of the backlight device 16 is the front cabinet (an example of a frame member) 11, and the cabinet that is exposed to the rear of the backlight device 16 is the rear cabinet (an example of sandwiching member or holding member) 12. The front cabinet 11 and the rear cabinet 12 form the exterior of the backlight device 16. A bezel 17 has a frame-plate shape along the display surface of the liquid crystal panel 14 described above and integrally holds together the liquid crystal panel 14 and a frame 18 by sandwiching the outer edge of the liquid crystal panel 14 between the frame 18 and the bezel itself.

The front cabinet 11 is composed of a frame section 11A, which is a frame-shaped surface along the display surface of the liquid crystal panel 14, and a cylindrical section 11B, which is a surface that extends in a cylindrical shape along the front to back direction (the Z axis direction) from the outer edge of the frame section 11A toward the rear side. The rear cabinet 12 has a shallow substantially box shape and is composed of a bottom surface 12A, which has a plate-like shape along the display surface of the liquid crystal panel 14, and an outer edge 12B, which rises slightly along the front to back direction from the outer edge of the bottom surface 12A toward the front side. The cylindrical section 11B of the front cabinet 11 and the outer edge 12B of the rear cabinet 12 are fixed to each other at the outer side of the backlight device 16. The manner in which the front cabinet 11 is fixed to the rear cabinet 12 is described later in detail.

As shown in FIG. 2, the backlight device 16 is formed by housing the main constituting components thereof in the space between the frame 18 and the chassis 22. The constituting components housed between the frame 18 and the chassis 22 at least include an optical member 19, a light guide plate 20, an LED unit LU, and a reflective sheet 24. A part of both side faces (light-entering faces) 20A on the long sides of the light guide plate 20 faces the LED unit LU and guides the light emitted from the LED unit LU toward the liquid crystal panel 14. The optical member 19 is placed on the front side of the light guide plate 20. The backlight device 16 according to the present embodiment uses the so-called edge-lit method (side-lit method) in which the light guide plate 20 and the optical member 19 are disposed directly under the liquid crystal panel 14, and the LED unit LU, which is a light source, is disposed on a side end face of the light guide plate 20. Each of the constituting components of the backlight device 16 is described in detail below.

The frame 18 is made of a synthetic resin such as plastic. As shown in FIG. 2, the frame is parallel to the optical member 19 and the light guide plate 20 (the display surface of the liquid crystal panel 14) and has an approximately frame-like shape in a plan view. The frame 18 extends along the periphery of the light guide plate 20 and can cover from the front side almost the entire periphery of the optical member 19 and the light guide plate 20 disposed on the rear side of the frame. At the same time, the frame 18 can receive (support) from the rear side thereof almost the entire periphery of the liquid crystal panel 14 disposed on the front side thereof. That is, the frame 18 is interposed between the optical member 19 and the liquid crystal panel 14. Also, the short sides of the frame 18 collectively cover from the front side the gaps between the edges of the light-entering faces 20A of the light guide plate 20 described later and the corresponding side surfaces 22B on the short sides of the chassis 22.

The optical member 19 has a horizontally-long quadrilateral shape in a plan view in a manner similar to the liquid crystal panel 14, and the size thereof (short side dimension and long side dimension) is almost identical to that of the liquid crystal panel 14. The optical member 19 is multilayered and disposed on the front side (light-exiting surface 20B side) of the light guide plate 20, which is described later, and is arranged so as to be sandwiched between the liquid crystal panel 14 (described above) and the light guide plate 20. Each of the three constituting members of the optical member 19 has a sheet-like shape and is stacked upon one another. Specific types of optical members 19 include a diffusion sheet, a lens sheet, a reflective polarizing sheet, and the like, for example. It is possible to appropriately choose any of these as the optical member.

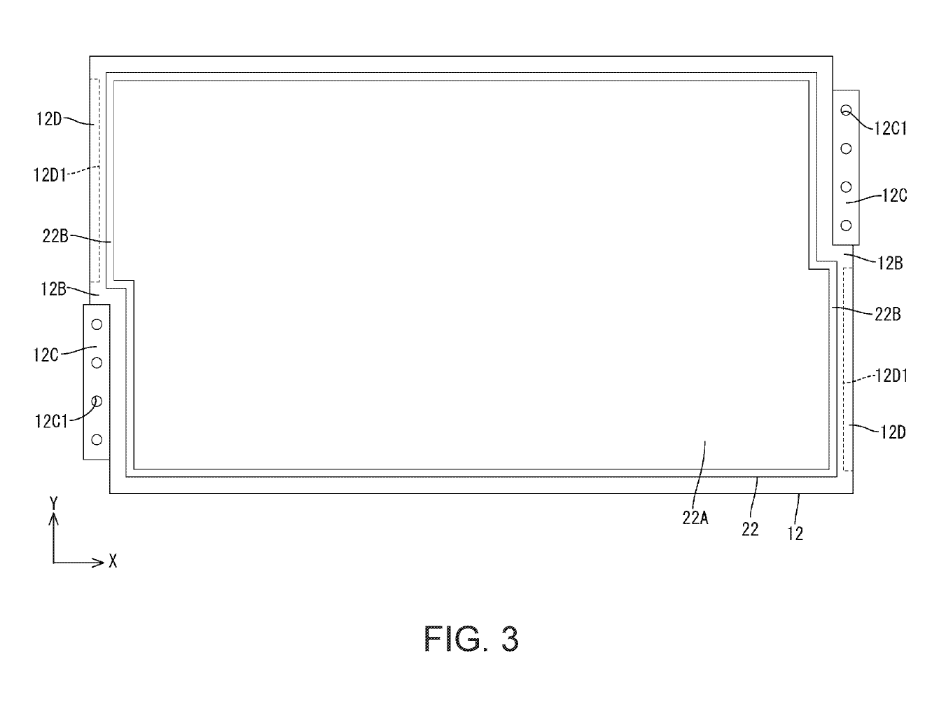

The chassis 22 is made of a metal plate such as an aluminum plate or an electro-galvanized cold-rolled steel (SECC), for example. As shown in FIGS. 2 and 3, the chassis is constituted by a bottom plate 22A having an approximately horizontally-long quadrangular shape similar to the liquid crystal panel 14, side walls 22B that rise from the respective outer edges of both of the short sides of the bottom plate 22A, and side walls that rise from the respective outer edges of both of the long sides of the bottom plate 22A. The long side direction of the chassis 22 (the bottom plate 22A) corresponds to the X axis direction (horizontal direction), and the short side direction to the Y axis direction (vertical direction). The side walls 22B of the chassis 22 and the frame 18 sandwich the light guide plate 20 and the like by having the tip of the side walls 22B of the chassis 22 abut the rear side of the frame 18. The bottom plate 22A extends along the light guide plate 20 and the reflective sheet 24 housed in the chassis 22 and supports the light guide plate and the reflective sheet from the rear side thereof via a heat-dissipating plate 32 and a cushioning member 34 described later. A control substrate (not shown) for providing a signal for driving a liquid crystal panel 14 is provided in the gap (not shown) between the outer rear side of the bottom plate 22A and the rear cabinet 12. In a manner similar to the control substrate described above, other substrates such as an LED driver circuit substrate (not shown) that provides driving power to the LED unit LU are attached to the bottom plate 22A.

As shown in FIG. 3, the outer edge of each of the short sides of the bottom plate 22A of the chassis 22 is not straight in a plan view. Approximately half of the outer edge is slightly off in the direction orthogonal to the light-entering face 20A (the X axis direction). Specifically, of the outer edges of the short sides of the bottom plate 22A, there is a portion in one of the outer edges that is shifted inwardly (toward the middle of the bottom plate 22A) along the direction orthogonal to the light-entering face 20A. The portion in the other outer edge facing the portion of the edge described above across the bottom plate 22A is shifted outwardly along the direction orthogonal to the light-entering face 20A. The side walls 22B on both of the short sides of the chassis 22 rise toward the front side from the outer edge of each of the short sides of the bottom plate 22A, which has a skewed shape as described above.

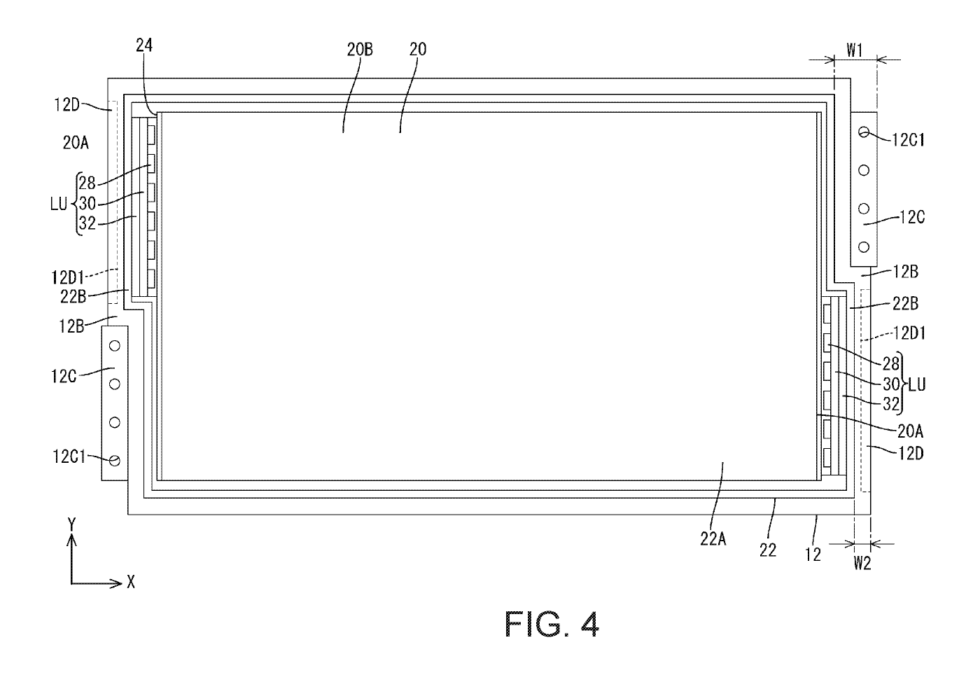

As shown in FIG. 4, in the backlight device 16 of the present embodiment, the LED unit LU is disposed on the inner side of the portion of the outer edge of each of the short sides of the bottom plate 22A of the chassis 22 that is shifted outwardly along the direction orthogonal to the light-entering face 20A. However, the LED unit LU is not disposed on the inner side of the portion of the outer edge of each of the short sides of the bottom plate 22A of the chassis 22 that is shifted inwardly along the direction orthogonal to the light-entering face 20A. In this configuration, of the pair of light-entering faces 20A that form the opposing short sides of the light guide plate 20, one LED unit LU disposed on one of the light-entering faces 20A is not located across from the other LED unit LU disposed on the other light-entering face 20A in the direction orthogonal to the light-entering face 20A.

The light guide plate 20 is made of a synthetic resin (an acrylic resin such as PMMA or a polycarbonate, for example) that has a refractive index that is sufficiently higher than that of air and almost completely transparent (has excellent light transmission characteristics). As shown in FIG. 2, the light guide plate 20 has a horizontally-long quadrangular shape in a plan view, in a manner similar to the liquid crystal panel 14 and the chassis 22, and is shaped like a plate that is thicker than the optical member 19. The long side direction of the surface of the light guide plate corresponds to the X axis direction, the short side to the Y axis direction, respectively, and the plate thickness direction intersecting with the surface corresponds to the Z axis direction. The side faces on the short sides of the light guide plate 20, or in other words the pair of end faces that form the opposing sides on the short sides thereof are the light-entering faces 20A. A part of each of the light-entering faces 20A faces the LEDs 28 that forms the LED unit LU described later, and the light emitted from the LEDs 28 enters into that part.

As shown in FIG. 2, the light guide plate 20 is disposed such that the light-existing surface 20B, which is the primary surface (the front surface), faces the optical member 19, and an opposite surface 20c, which is the surface opposite to a light-exiting surface 20B (the rear surface), faces the reflective sheet 24. The light guide plate 20 is supported by the heat-dissipating member 32 and the cushioning member (described later) via the reflective sheet 24. In other words, the direction in which the light guide plate 20 aligns with the LED unit 32 corresponds to the Y axis direction, and the direction in which the light guide plate 20 aligns with the optical member 19 and the reflective sheet 24 corresponds to the Z axis direction. The light guide plate 20 has a function of receiving light emitted from the LED unit LU along the Y axis direction through the light-entering face 20A, propagating the light therethrough while changing the direction of the light toward the optical member 19, and emitting the light through the light-exiting surface 20B. On at least either one of the light-exiting surface 20B or the opposite surface 20C of the light guide plate 20, reflective parts (not shown) that reflect internal light or diffusion parts (not shown) that diffuse internal light are patterned so as to have a prescribed surface distribution, thereby controlling the light emitted from the light-exiting surface 20B of the light guide plate 20 so as to have an even distribution across the surface.

The reflective sheet 24 has the shape of a rectangular sheet, is made of a synthetic resin, and the surface thereof is white with excellent light-reflecting characteristics. The long side direction of the reflective sheet 24 corresponds to the X axis direction, and the short side direction thereof corresponds to the Y axis direction. The front side of the reflective sheet 26 has a reflective surface, and this reflective surface abuts the opposite surface 20C, entirely covering the opposite surface 20C of the light guide plate 20. The reflective sheet 24 can reflect the light that leaked from the LED unit LU or the opposite surface 20C of the light guide plate 20. As shown in FIG. 2, the edges of the reflective sheet 24 on the light-entering face 20A side slightly stick out from the corresponding light-entering face 20A. This configuration enables the light emitted from the LED unit LU and heading directly toward the reflective sheet 24 to be reflected toward the light-entering face 20A.

As shown in FIG. 4, the LED unit LU is provided along each of the short sides of the chassis 22, and the length in the length direction thereof is about a half of the length of the short side of the chassis. Each of the LED units LU is constituted by the LEDs 28, an LED substrate 30, and the heat-dissipating plate 32. Of the LED units LU provided across from the pair of light-entering faces 20A that form the opposing short sides of the light guide plate 20, the LED unit LU disposed on one side of the light-entering faces 20A is not located across from the other LED unit LU disposed on the other side of the light-entering face 20A in the direction orthogonal to the light-entering face 20A (the X-axis direction). Specifically, one of the LED units LU is disposed closer to one end of the light-entering face 20A (closer to the lower side in FIG. 4), and the other LED unit LU is disposed closer to the other end of the light-entering face 20A (closer to the upper side in FIG. 4). In this configuration, the LED units LU are disposed such that they do not face each other across the light guide plate 20 in the plan view shown in FIG. 4.

Each of the LEDs 28 that constitutes the LED unit LU is made by sealing an LED chip (not shown) by a resin on a substrate section that is fixed to the LED substrate 30. The LED chip mounted on the substrate portion has one primary wavelength, specifically emitting only blue light. On the other hand, a phosphor that emits a prescribed color when excited by blue light emitted from the LED chip is dispersed in the resin package that seals the LED chip, and the LED chip as a whole emits light that is largely white. For the phosphor, a yellow phosphor that emits yellow light, a green phosphor that emits green light, and a red phosphor that emits red light can be combined appropriately for use, or only one of the phosphors can be used, for example. The LEDs 28 are a so-called top-emitting type, for which the primary light-emitting face is the surface opposite to the mounting surface of the LED substrate 30 (the surface facing the light-entering face 20a of the light guide plate 20).

As shown in FIGS. 2 and 3, the LED substrate 30 that constitutes the LED unit LU has a narrow plate shape extending along the short side direction (the Y axis direction) of the light guide plate 20 and is housed in the chassis 22 such that the surface thereof is parallel to the Y axis direction and the Z axis direction, or in other words parallel to the light-entering face 20A of the light guide plate 20. The length in the long side direction (the Y axis direction) of each of the LED substrates 30 is about half as long as the length in the short side direction (the Y axis direction) of the light guide plate 20. On the inner surface of the LED substrate 30, or in other words on the surface facing the light guide plate 20 (the surface opposing the light guide plate 20), the LEDs 28 having the configuration described above are mounted. This surface is considered to be a mounting surface. A plurality of the LEDs 28 are disposed on the mounting surface of the LED substrate 30 along the length direction (the X axis direction) thereof in a row (in a straight line) with prescribed gaps therebetween. That is, the plurality of the LEDs 28 are disposed in a row intermittently on each of the edges of the short sides of the backlight device 16 along the short side direction thereof. The gaps between the adjacent LEDs 28 along the Y axis direction, or in other words the array pitch of the LEDs 28, is approximately the same. The alignment direction of the LEDs 28 coincides with the long side direction (the Y axis direction) of the LED substrate 30. A wiring pattern (not shown) made of metal film (copper foil, for example) is formed on the mounting surface of the LED substrate 30. The wiring pattern extends along the X axis direction and goes across the group of LEDs 28 connecting the adjacent LEDs 28 in series. By connecting to a power supply board via a wiring member such as a connector or a cable, terminals formed at both ends of the wiring pattern supply driving power to each of the LEDs 28. The LED substrate 30 is attached to the heat-dissipating plate 32 described next.

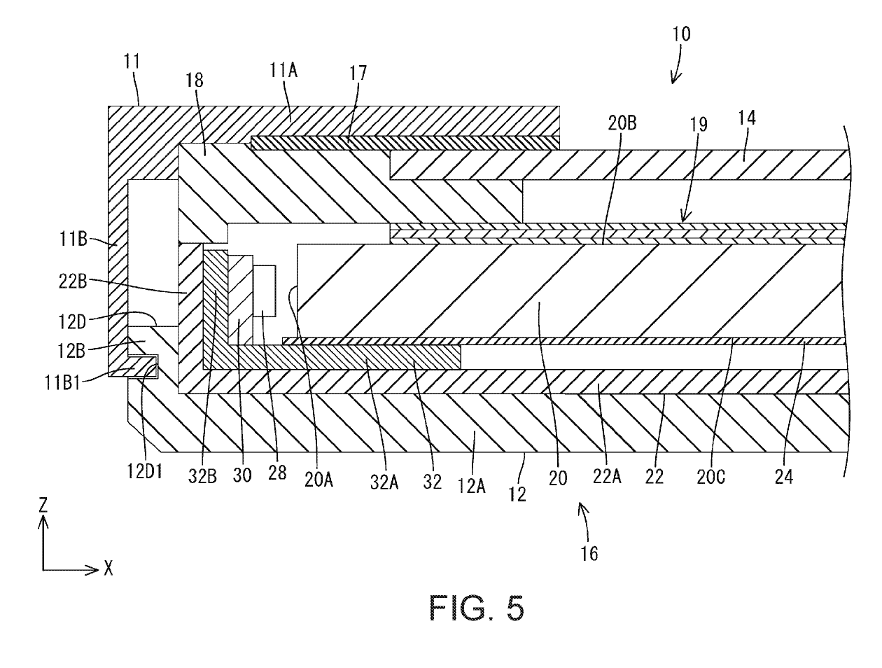

The heat-dissipating plate 32 that constitutes the LED unit LU is made of metal such as aluminum that has excellent heat conductivity, for example. As shown in FIG. 5, the heat-dissipating plate 32 includes a rising section 32B to which the LED substrate 30 is attached and a bottom surface 32A that touches the surface of the bottom plate 22A of the chassis 22. In a cross-sectional view, these two parts together have a bent shape that is approximately in the shape of an “L.” The length of the long side of the heat-dissipating plate 32 is approximately the same as that of the LED substrate 30. As shown in FIG. 5, the bottom surface 32A that constitutes the heat-dissipating plate 32 has a plate-like shape that is parallel to the bottom plate 22A of the chassis 22, and the long side direction thereof corresponds to the Y axis direction, the short side direction to the X axis direction, and the thickness direction to the Z axis direction, respectively. The bottom surface 32A is formed so as to protrude from the edge on the rear side of the rising portion 32B (the edge on the side of the chassis 22) towards the inner side along the X axis direction, in other words towards the middle of the light guide plate 20. A large part of this section corresponds to the rear side of the light guide plate 20 and is located on the rear side of the reflective sheet 24. In other words, a large part of the bottom surface 32A is sandwiched (interposed) between the reflective sheet 24 and the chassis 22. The entire back surface of the bottom surface 32A, or in other words the entire surface facing the chassis 22, touches the bottom plate 22A of the chassis 22. In this configuration, the heat conducted from the LEDs 28 to the heat-dissipating plate 32 is efficiently dissipated from the bottom surface 32A toward the bottom plate 22A of the chassis 22.

As shown in FIG. 5, the rising portion 32B that constitutes the heat-dissipating plate 32 rises from the outer edge of the bottom surface 32A (the opposite side from the light guide plate 20 side) perpendicularly to the bottom surface 32A. The rising portion 32B has a plate-like shape that runs parallel to the surface of the LED substrate 30 and the light-entering face 20A of the light guide plate 20, and the long side direction thereof corresponds to the Y axis direction, the short side direction to the Z axis direction, and the thickness direction to the X axis direction, respectively. The LED substrate 30 is attached to the inner surface of the rising portion 32B, or in other words the surface facing the light guide plate 20, by a screw or the like (not shown). The length of the long side of the rising portion 32B is approximately the same as that of the LED substrate 30. The surface of the rising portion 32B that is on the outer side thereof touches the side wall 22B of the chassis 22. A screw is used to fix the bottom surface 32A of the heat-dissipating plate 32 to the bottom plate 22A, thereby fixing the heat-dissipating plate 32 to the chassis 22.

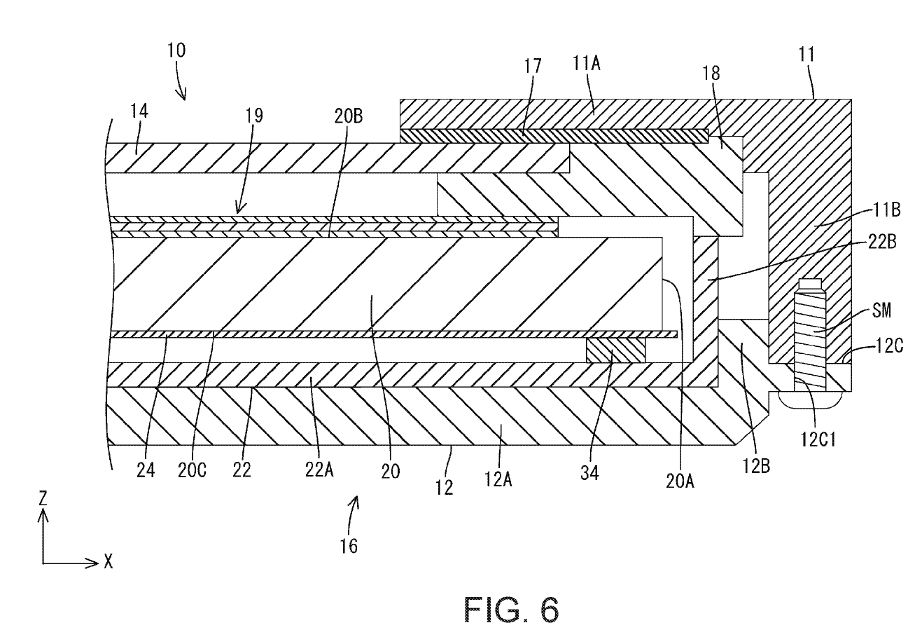

For the portion where the LED unit LU is disposed, there is space between the reflective sheet 24 and the bottom plate 22A of the chassis 22 because, as described above, the bottom surface 32A of the heat-dissipating plate 32 is interposed between the reflective sheet 24 and the bottom plate 22A of the chassis 22. However, for the portion where the LED unit LU is not disposed, the cushioning member 34 is disposed between the reflective sheet 24 and the bottom plate 22A of the chassis 22 (see FIG. 6). In this configuration, the cushioning member 34 supports the reflective sheet 24 and the light guide plate 20 with respect to the bottom plate 22A of the chassis 22.

The detailed configuration of the rear cabinet 12 and the manner in which the front cabinet 11 and the rear cabinet 12 are fixed are described next. Consider in FIG. 3, the portion of the outer edge 12B of the rear cabinet 12 that is located on the outer side of each of the short sides of the chassis 22. As shown in the figure, this portion is provided along each of the short side edges of the bottom plate 22A, which has a skewed shape as described above. In this configuration, there is a portion of the outer edge 12B, located on the outer side of the portion of the outer edges of the short sides of the bottom plate 22A, that is shifted inwardly in the direction orthogonal to the light-entering face 20A (referred to as a fixed portion 12C below). This portion has more space compared to the portion of the outer edge 12B, located on the outer side of the portion of the outer edges of the short sides of the bottom plate 22A, that is shifted outwardly in the direction orthogonal to the light-entering face 20A (referred to as a locking part 12D). As a result, in the outer edge 12B of the rear cabinet 12, the width W1 (referred to as the orthogonal direction width below) in the direction orthogonal to the light-entering face 20A (the X axis direction) of the fixed portion 12C is wider than the orthogonal direction width W2 of the locking part 12D (see FIGS. 3 and 4).

As shown in FIGS. 3 and 4, screw holes 12C1 that penetrate the fixed portion 12C in the front and rear direction (the Z axis direction) are provided in the fixed portion 12C described above, which is a part of the outer edge 12B of the rear cabinet 12. A plurality of the screw holes 12C1 are provided in the fixed portion 12C along the short side direction (the Y axis direction) of the chassis 22. As shown in FIG. 6, screws SM are inserted from the back side of the screw holes 12C1. The tip of each of the screws is screwed into the cylindrical section 11B of the front cabinet 11. As described above, the rear cabinet 12 is fixed firmly to the front cabinet 11 by having the rear cabinet 12 fixed to the front cabinet 11 with the screws at the fixed portion 12C.

As shown in FIG. 5, a recess 12D1, which has an opening toward the outer side (the side opposite to the light guide plate 20 side), is provided in the locking part 12D described above, which is a part of the outer edge 12B of the rear cabinet 12. As shown in FIGS. 3 and 4, the recess 12D1 is provided so as to extend along the short side direction (the Y axis direction) of the chassis 22 in the locking part 12D. However, as shown in FIG. 5, the tip of the cylindrical section 11B of the front cabinet 11 that overlaps the locking part 12D in the front and rear direction (the Z axis direction) extends to the opening of the recess 12D1 and bends approximately perpendicularly toward the recess 12D1 side in a tab-like shape. This part that is bent in the tab-like shape (referred to as the tab below) 11B1 is inserted into the recess 12D1. In this configuration, the recess provided in the locking part 12D of the rear cabinet 12 engages with the tab 11B1 provided on the tip of the frame section 11B of the front cabinet 11. As a result, the locking part 12D of the rear cabinet 12 is locked to the frame section 11B of the front cabinet 11.

Normally, a plurality of members that sandwich the light guide plate in an edge-lit type backlight device are fixed to each other by fixing members or the like. In addition to the LEDs, supporting members such as LED substrates are provided on the portion of the region, located on the outer side of the light-entering face of the light guide plate, where the LEDs are disposed. Suppose that a fixing structure used to fix the plurality of members for sandwiching the light guide plate therebetween were provided on the outer side of the supporting members. In this case, if the width in the direction orthogonal to the light-entering face where the fixing structure is provided is widened, narrowing the frame region of the backlight device becomes difficult. On the other hand, suppose that the width in the direction orthogonal to the light-entering face of the portion where the fixing structure is provided is made smaller in order to narrow the frame region of the backlight device. In that case, the fixing members or the like used to fix the two members sandwiching the light guide plate to that portion cannot be provided, and fixing the two members in a favorable manner becomes difficult. This raises a concern that the strength of the backlight device might be reduced.

To address this point, in the backlight device 16 according to the present embodiment, the front cabinet 11 and the rear cabinet 12 are provided so as to sandwich the light guide plate 20, and the front cabinet 11 and the rear cabinet 12 are fixed at the fixed portion 12C. As described above, at the fixed portion 12C of the rear cabinet 12, both of the cabinets 11 and 12 are firmly fixed with the screws, and at the locking part 12D of the rear cabinet 12, both of the cabinets 11 and 12 are locked by engaging each other. In this configuration, the front cabinet 11 and the rear cabinet 12 sandwich the light guide plate 20 and are fixed to each other in a favorable manner. Thus, this configuration can prevent or restrain the reduction in the strength of the backlight device 16.

In addition, the fixed portion 12C is the outer portion of the region in the rear cabinet 12 where the LED unit LU is not provided. In the fixed portion 12C, the orthogonal direction width worth of space needed to provide the LED unit LU can be used as the space for providing the screw holes 12C1 for inserting the screws SM. Thus, this configuration can restrain the width of the frame region of the backlight device 16 that corresponds to the fixed portion 12C from getting wider. On the other hand, the locking part 12D is the outer portion of the region in the rear cabinet 12 where the LED unit LU is provided. Here, the orthogonal direction width needed for providing the recess 12D1 is much smaller compared to the orthogonal direction width needed to provide the screw holes 12C1. Because of this, this configuration can restrain the width of the frame region of the backlight device 16 that corresponds to the locking part 12D from getting wider while securing the orthogonal direction width worth of space needed for proving the recess 12D1 in the locking part 12D. In this way, the backlight device 16 according to the present embodiment can restrain the width of the frame region from getting wider along the entire periphery of the frame.

As described above, in the backlight device 16 according to the present embodiment, the fixed portion 12C is the region, located on the outer side of the light-entering face 20A of the light guide plate, where the LEDs 28 and the like are not disposed. In this configuration, the space in the fixed portion 12C that becomes unoccupied because the LEDs 28 and the like are not provided can be used as the space for disposing the screws SM. Thus, even when the orthogonal direction width of the fixed portion 12C is made wider, the frame region of the backlight device 16 can be made narrower. As a result, both of the cabinets 11 and 12 that sandwich the light guide plate 20 are fixed at the fixed portion 12C in a favorable manner. Thus, this configuration can prevent or restrain the reduction in the strength of the backlight device 16. As described above, the backlight device 16 according to the present embodiment can prevent or restrain the reduction in the strength of the backlight device while narrowing the frame region.

In the present embodiment, the light guide plate 20 has a quadrangular shape, and each of the end faces that form the opposing short sides of the light guide plate 20 is the light-entering face 20A. In this configuration, the brightness of the backlight device 16 can be improved because light is allowed to enter from both of the end faces that form the opposing short sides of the light guide plate 20. In the rear cabinet 12, the fixed portion 12C is provided on each of the end faces that form the opposing short sides of the light guide plate 20. Thus, the rear cabinet 12 can be fixed to the front cabinet 11 in a favorable manner.

In addition, in the present embodiment, of the LED units LU provided across from the pair of light-entering faces 20A that form the opposing short sides of the light guide plate 20, one LED unit LU disposed on one side of the light-entering faces 20A is not located across from the other LED unit LU disposed on the other side of the light-entering face 20A in the direction orthogonal to the light-entering face 20A. In this configuration, a plurality of the fixed portions 12C are provided such that they do not face each other when viewing the light guide plate 20 in a plan view, and the plurality of the fixed portions 12C become distributed equally on the rear cabinet 12. Thus, the rear cabinet 12 can be fixed to the front cabinet 11 in a favorable manner.

The present embodiment includes the screws SM that fix the rear cabinet 12 to the front cabinet 11 at the fixed portion 12C by having the screws penetrate through the front cabinet 11 and the screw holes 12C 1 provided in the rear cabinet 12. The locking part 12D that locks to the front cabinet 11 is provided in the region in the rear cabinet 12 that is located opposite to the portion of the end face, defined as the light-entering face 20A, that faces the LED unit LU. This configuration allows the narrowing of the frame region of the backlight device 16 while securing a large space for the orthogonal direction width in the fixed portion 12C in order to dispose the screws SM in the fixed portion 12C. Thus, using the screws SM, the rear cabinet 12 can be firmly fixed to the front cabinet 11. Furthermore, the locking structure of the locking part 12D has a narrower orthogonal direction width compared to that of the fixed portion 12C in which the screws SM and the like are disposed. Thus, the rear cabinet 12 can be locked to the front cabinet 11 at the locking part 12D while narrowing the frame region of the backlight device 16. As described above, the present embodiment can further prevent or restrain the reduction in the strength of the backlight device 16 by locking the rear cabinet 12 to the front cabinet 11 at a portion other than the fixed portion 12C while narrowing the frame region of the backlight device 16.

In the present embodiment, the rear cabinet 12 locks to the front cabinet 11 because the recess 12D1 engages with the tab 11B1 at the locking part 12D. This configuration allows the rear cabinet 12 to be locked to the front cabinet 11 without using locking members or the like at the locking part 12D, thereby reducing material cost. Also, the frame region of the backlight device 16 can be further narrowed because the orthogonal direction width of the locking structure of the locking part 12D can be made smaller compared to when using the locking members or the like.

In the present embodiment, both of the front cabinet 11 and the rear cabinet 12 are configured to be the members that form the exterior of the backlight device 16. In the configuration in which a pair of the exterior members that form the exterior of the liquid crystal display device 10 are fixed to each other, the frame region of the backlight device 16 can be narrowed while preventing or restraining the reduction in the strength of the backlight device.

It should be mentioned that, in the present embodiment, the fixed portion 12C can be disposed in accordance with the region where the LED units LU are disposed. Thus, each of the LED units LU can be selectively disposed with respect to the light-entering faces 20A of the light guide plate 20. Because of this, the LEDs 28 can be placed in any location.

### Modification Example 1 of Embodiment 1

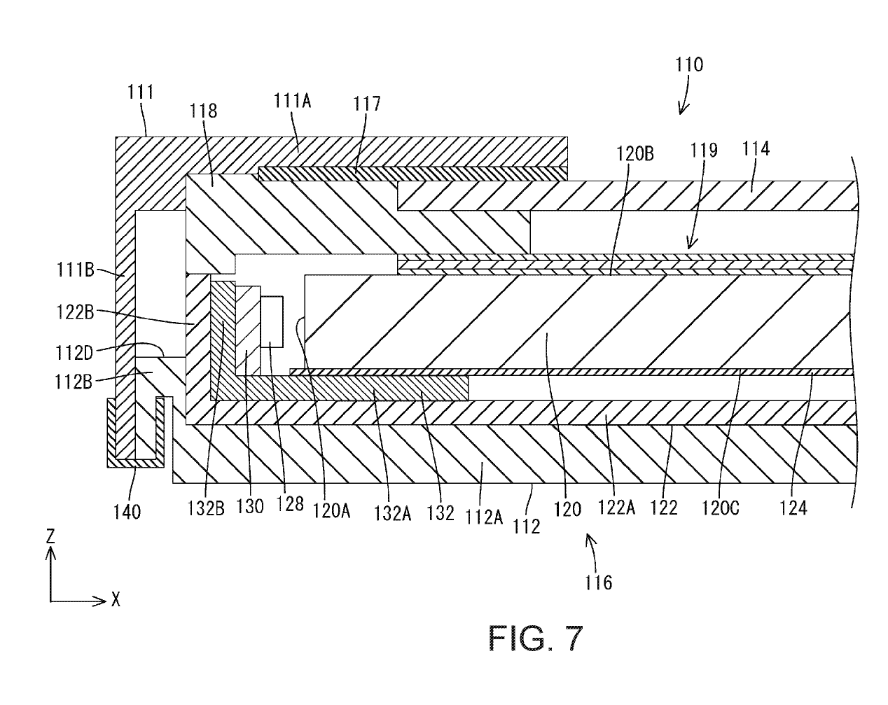

Modification Example 1 of Embodiment 1 will be described with reference to FIG. 7. Parts in FIG. 7 are the same as those parts in FIG. 5 that have had 100 added thereto. In Modification Example 1, the locking structure in a locking part 112D of a rear cabinet 112 differs from that of Embodiment 1. In Modification Example 1, as shown in FIG. 7, the tip of the locking part 112D in an outer edge 112B of the rear cabinet 112 extends toward the rear side. The tip of the part of a cylindrical section 111B of the front cabinet 111 that overlaps the locking part 112D abuts the extending part described above. A clip 140 sandwiches the tip of the cylindrical section 111B and the extending part of the locking part 112D described above as they touch each other, thereby fixing these parts together. Here, the orthogonal direction width of the locking part 112D needed for fixing using a clip is much smaller compared to the orthogonal direction width needed for disposing screw holes. Because of this, even when the locking structure in the locking part 112D has the aspect described above, this configuration can restrain the width of the frame region of the backlight device 16 corresponding to the locking part 112D from getting wider while securing the orthogonal direction width worth of space needed for fixing using a clip at the locking part 112D.

### Modification Example 2 of Embodiment 1

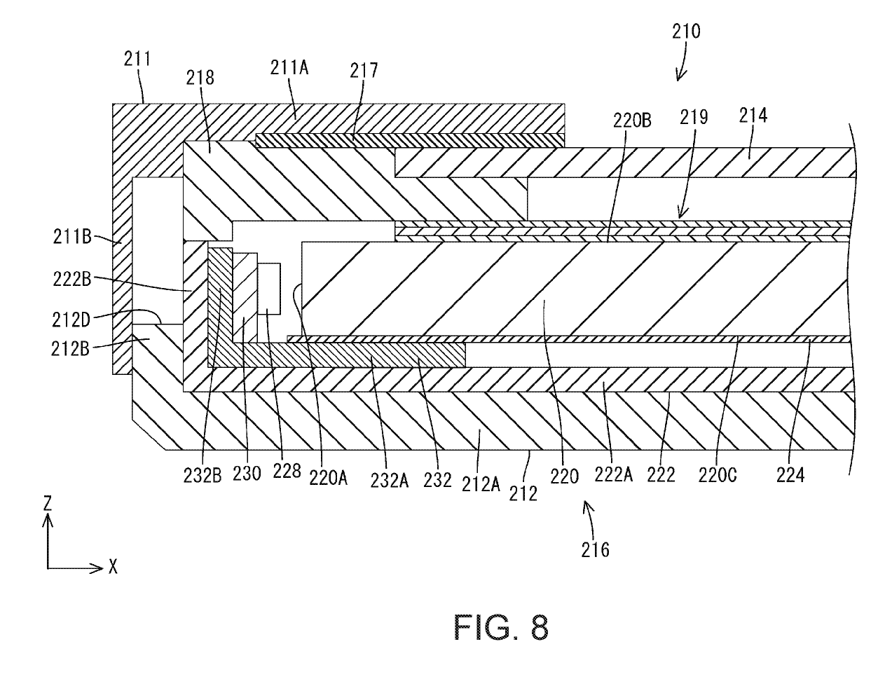

Next, Modification Example 2 of Embodiment 1 will be described with reference to FIG. 8. Parts in FIG. 8 are the same as those parts in FIG. 5 that have had 200 added thereto. In an outer edge 212B of a rear cabinet 212 in Modification Example 2, a structure of the part that corresponds to the locking part of Embodiment 1 differs from that of Embodiment 1. In Modification Example 2, as shown in FIG. 8, the part of the rear cabinet 212 that corresponds to the locking part 12D in Embodiment 1 becomes an abutting portion 212D. The tip of the part of a cylindrical section 111B of the front cabinet 111 that overlaps the abutting portion 212D touches the abutting portion 212D described above. In other words, the abutting portion 212D differs from Embodiment 1 in that a part of the rear cabinet 212 and a part of a front cabinet 211 merely touch each other. Even with such a configuration, the backlight device can prevent or restrain the reduction in the strength of the backlight device 216, because the rear cabinet 212 is fixed to the front cabinet 211 firmly by screws at the fixed portion.

In the present modification example, the orthogonal direction width of the part where the locking structure or the like is provided can be made narrower compared to when providing the locking structure or the like in the region on the outer side of the LED unit LU, or in other words the region across from the LED unit LU and opposite from the portion of the end face defined as the light-entering face 20A. In this configuration, the frame region of the backlight device 216 can be made even narrower.

### Embodiment 2

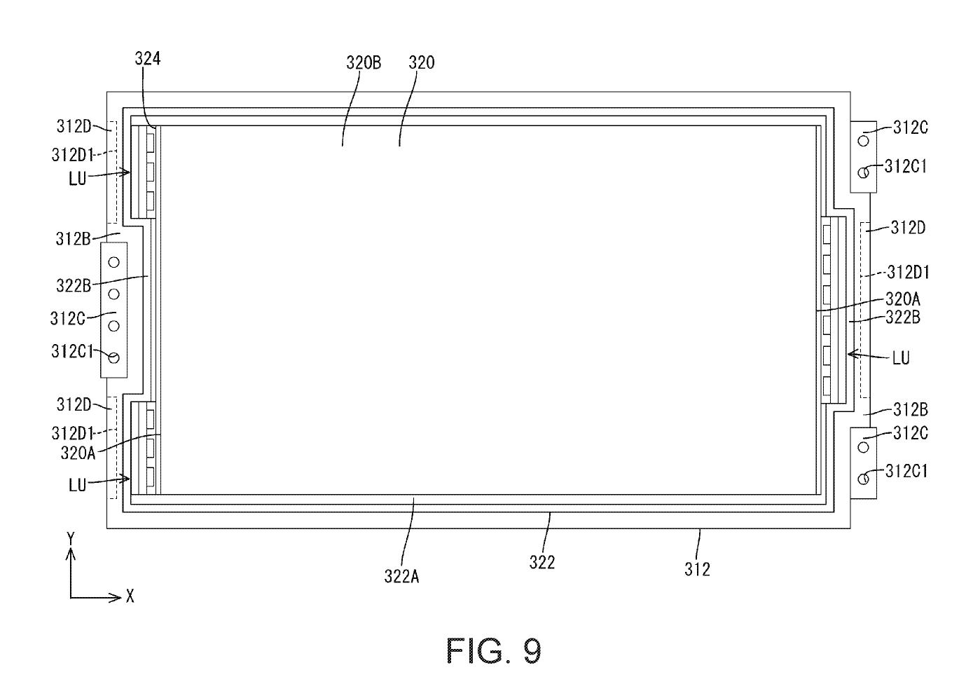

Embodiment 2 is described with reference to the drawings. In Embodiment 2, the arrangement of LED units LU and fixed portions 312C differs from that of Embodiment 1. Other configurations are similar to those of Embodiment 1; thus, repetitive descriptions of the configurations, operation, and effects are omitted. Parts in FIG. 9 that have 300 added to the reference characters of FIG. 4 are the same as these parts described in Embodiment 1.

In a backlight device according to Embodiment 2, as shown in FIG. 9, the end faces on the short sides of the light guide plate 320, or in other words a pair of end faces that form the opposing short sides thereof, are light-entering faces 320A in a manner similar to Embodiment 1. In the region outside one of light-entering faces 320A in outer edges 312B of a rear cabinet 312, the fixed portion 312C is provided outside each of the ends in the long side direction (the Y axis direction) of the light-entering face 320A, and a locking part 312D is provided outside the middle of the light-entering face. Similarly, in the region outside the other light-entering face 320A, in the outer edges 312B of the rear cabinet 312, the locking parts 312D are provided outside each of the ends in the long side direction of the light-entering face 320A, and the fixed portion 312C is provided outside the middle of the light-entering face. In this configuration, the LED units LU are disposed such that they do not face each other across the light guide plate 320 in the plan view shown in FIG. 9. In the present embodiment, a plurality of the fixed portions 312C are provided in the region on the outer side of one of the light-entering faces 320A, and a plurality of the locking parts 312D are provided in the region on the outer side of the other light-entering face 320A. Even this configuration can narrow the frame region of the backlight device while preventing or restraining the reduction in the strength of the backlight device.

### Embodiment 3

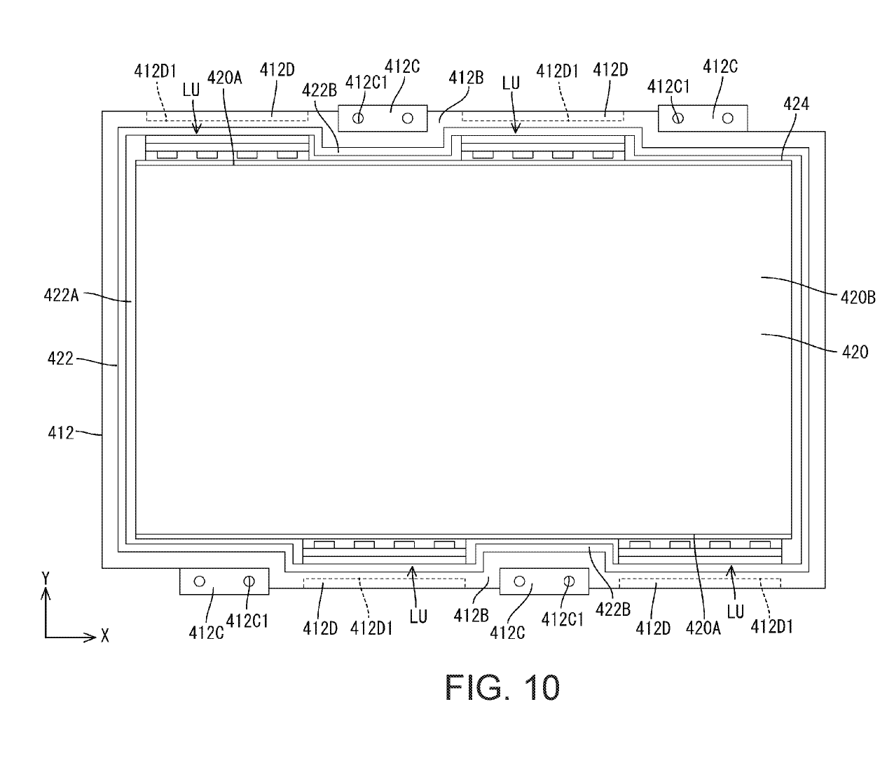

Embodiment 3 is described with reference to the drawings. In Embodiment 3, the arrangement of LED units LU and fixed portions 412C differs from that of Embodiment 1. Other configurations are similar to those of Embodiment 1; thus, the descriptions of the configurations, operation, and effects are omitted. Parts in FIG. 10 that have 400 added to the reference characters of FIG. 4 are the same as the corresponding parts described in Embodiment 1.

In a backlight device according to Embodiment 3, as shown in FIG. 10, the end faces on the long sides of the light guide plate 420, or in other words a pair of end faces that form the opposing long sides thereof, are light-entering faces 420A. Two fixed portions 412C and two locking parts 412D are alternately arranged outside the rear cabinet 312 in an area outside one of the light-entering faces 420A. In the area outside the other light-entering face 420A, the locking parts 412D are provided directly across the fixed portions 412C on the opposite side of the light-entering face 420A such that the locking parts and the corresponding fixed portions sandwich the light guide plate 420. Similarly, in the area outside the other light-entering face, the fixed portions 412C are provided directly across the locking parts 412D provided on the opposite side of the light-entering face 420A such that the fixed portions and the corresponding locking parts sandwich the light guide plate 420. Thus, in the region located on the outer side of this other light-entering face 420A, the two fixed portions 412C and the two locking parts 412D are disposed alternately on the outer edge of the rear cabinet 412. In this configuration, the LED units LU are disposed such that they do not face each other across the light guide plate 420 in the plan view shown in FIG. 10. In the present embodiment, a plurality of the fixed portions 412C and a plurality of the locking parts 412D are respectively provided in the region on the outer side of each of the light-entering faces 420A. Even this configuration can narrow the frame region of the backlight device while preventing or restraining the reduction in the strength of the backlight device.

### Embodiment 4

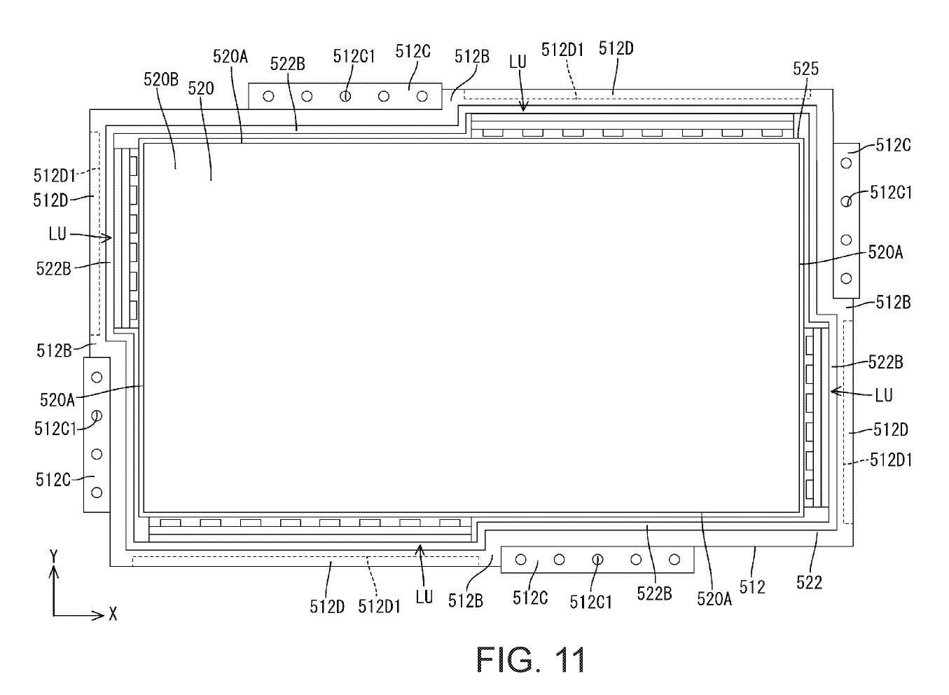

Embodiment 4 is described with reference to the drawings. In Embodiment 4, the arrangement of LED units LU and fixed portions 512C differs from that of Embodiment 1. Other configurations are similar to those of Embodiment 1; thus, repetitive descriptions of the configurations, operation, and effects are omitted. Parts in FIG. 11 that have 500 added to the reference characters of FIG. 4 are the same as the corresponding parts described in Embodiment 1.

In a backlight device according to Embodiment 4, as shown in FIG. 11, all the end faces of the light guide plate 520 are light-entering faces 520A. In the outer edges of the rear cabinet 512, the one fixed portion 512C and one locking part 512D are provided on each outer side of each light-entering face 520A. The fixed portions 512C and the locking parts 512D disposed on the outer end portions of the rear cabinet 512 are alternately arranged along the periphery surrounding the light guide plate 520. Thus, in the outer edges 512B of the rear cabinet 512, the fixed portion 512C and the locking part 512D are disposed such that they form a pair across the light guide plate 520 in the long side direction (the X axis direction) and the short side direction (the Y axis direction) of the light guide plate 520. In the present embodiment, even this configuration can narrow the frame region of the backlight device while preventing or restraining the reduction in the strength of the backlight device. In addition, in the present embodiment, light enters from each of the end faces of the light guide plate 520 because all the end faces of the light guide plate 520 are the light-entering faces 520A. Thus, the brightness in the display surface of the liquid crystal panel 514 can be increased.

### Embodiment 5

Embodiment 5 is described with reference to the drawings. Embodiment 5 differs from Embodiment 1 in that the backlight device 616 does not include cabinets. Other configurations are similar to the backlight device 16 that includes the front cabinet 11 and the rear cabinet 12 according to Embodiment 1; thus, the descriptions thereof are omitted.

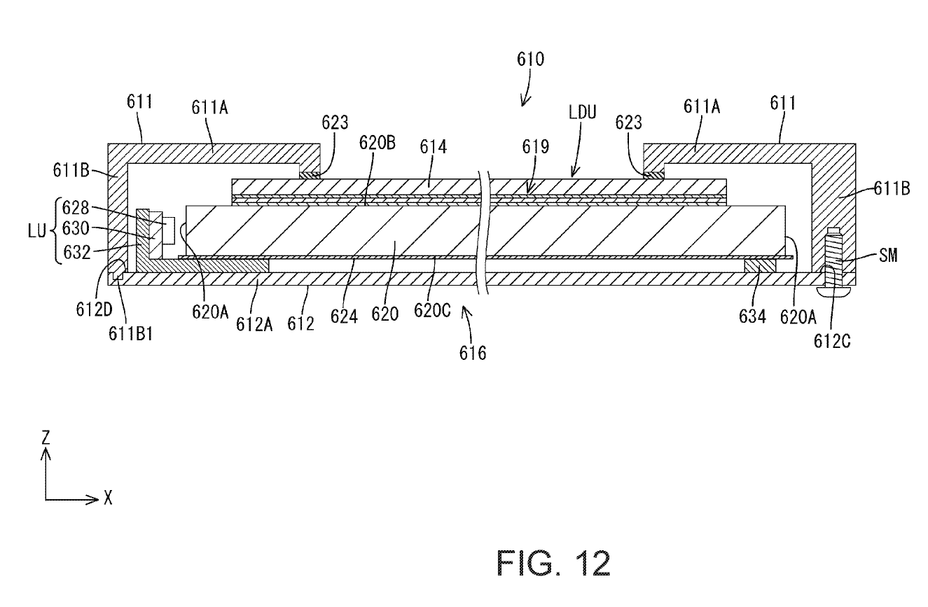

As shown in FIG. 12, the main constituting components of the backlight device 616 according to Embodiment 5 are housed in the space between a frame (one example of a frame member) 611, which forms the front exterior, and a chassis (one example of a sandwiching member) 612, which forms the rear exterior. The main constituting components that are housed in the frame 611 and the chassis 612 at least include an optical member 619, a light guide plate 620, and a LED unit LU. Of these, the liquid crystal panel 614, the optical member 619, and the light guide plate 620 are stacked on one another and held by being sandwiched by the frame 611 on the front side thereof and the chassis 612 on the rear side thereof. In a manner similar to Embodiment 1, both end faces on the short sides of the light guide plate 620 are light-entering faces 620A. In a manner similar to Embodiment 1 or 4, the LED unit LU is constituted by LEDs 628, a LED substrate 630 on which the LEDs 628 are mounted, and a heat-dissipating plate 632 that is in the shape of an “L” in a cross-sectional view and to which the LED substrate 530 is attached. In the present embodiment, combining this backlight device 616 and the liquid crystal panel 614 makes the liquid crystal display device 610.

The frame 611 includes a panel pressing portion 611A that is parallel to the display surface of the liquid crystal panel 614 and presses the liquid crystal panel 611 from the front side via a cushioning member 623 and a side wall 611B that protrudes toward the rear side from the periphery of the panel pressing portion 611A, and has a cross-section that is approximately in the shape of an “L.” In the backlight device 616, of the outer edge of the chassis 612, the fixed portion 612C is provided on the outer side, in the direction orthogonal to the light-entering face 620A, of the outer edge of the chassis 612 where the LED unit LU is not disposed, and the locking part 612D is provided outside where the LED unit LU is disposed.

In a manner similar to Embodiment 1, in the fixed portion 612C in the backlight device 616, screws SM are used to fix the frame 611 to the chassis 612, thereby firmly fixing the frame 611 to the chassis 612. On the other hand, in the locking part 612D, a groove that opens toward the front side and having a recessed shape in a cross-sectional view extends along the short side direction of the light guide plate 620. On the portion of the side wall 611B of the frame 611 that faces the groove described above, a rib 611B1 that protrudes toward the back side in a protruding shape extends in a short side direction of the light guide plate 620. In the locking part 612D, the frame 611 is locked to the chassis 612 by engaging the groove with the rib 611B1.

As described above, in the backlight device 616 according to the present embodiment, the frame 611 and the chassis 612 are disposed so as to sandwich the light guide plate 620. In the fixed portion 612C of the chassis 612, screws are used to fix the chassis 612 firmly to the frame 611. The frame 611 is locked to the chassis 612 by engaging each other at the locking part 612D of the chassis 612. Because of this, the chassis 612 and the frame 611 are fixed in a favorable manner as they sandwich the light guide plate 620, and the configuration can prevent or restrain the reduction in the strength of the backlight device 616. Furthermore, in the fixed portion 612C of the backlight device 616, the orthogonal direction width worth of space needed to dispose the LED unit LU can be used as the space for providing the screw holes for inserting the screws SM. Thus, this configuration can restrain the width of the frame region of the backlight device 616 that corresponds to the fixed portion 612C from getting wider. In the locking part 612D, this configuration can restrain the width of the frame region of the backlight device 616 corresponding to the locking part 612D from getting wider while securing the orthogonal direction width worth of space needed for providing the groove. Even in the backlight device 616 according to the present embodiment that does not have cabinets, the frame region of the backlight device can be narrowed while preventing or restraining the reduction in the strength of the backlight device 616.

Modification examples of the respective embodiments mentioned above are described below.

(1) In the respective embodiments described above, a configuration in which fixed portions and locking parts are disposed sandwiching the light guide plate so as to form a pair was used as an example. The fixed portions were disposed on the outer side of the region where the LED unit or the like are not disposed, and the locking parts were disposed on the outer side of the region where the LED units or the like are disposed. However, it is sufficient if the fixed portions and the locking parts are provided in the outer region of one of the light-entering faces, and the arrangement of the fixed portions and the locking parts are not limited to the above.

(2) In the respective embodiments described above, a configuration in which both of the cabinets, or the chassis and the frame, were fixed using screws at the fixed portion was used as an example. However, the fixing structure at the fixed portion is not limited to the above. A complex engaging structure may be provided in the fixed portion, and a configuration in which both of the cabinets or the like are firmly fixed by this engaging structure may be used, for example.

(3) In the respective embodiments described above, a configuration in which both of the cabinets, or the chassis and the frame, were locked by engaging each other was used as an example. However, the locking structure at the locking parts is not limited to the above.

(4) In the respective embodiments described above, an example in which a fixed portion is provided on a member that forms the exterior of the backlight device was shown. However, a member that does not form the exterior of the backlight device may also be used. A configuration in which the fixed portion is provided on the chassis or the like in Embodiment 1 may be used, for example.

(5) In the respective embodiments described above, a configuration in which a part of the area outside one of the light-entering faces that is not the fixed portion is the locking part or the abutting portion was used as an example. However, the parts where the fixed portion is not provided is not limited to the above. In the parts where the fixed portion is not provided, a configuration in which both of the cabinets sandwiching the light guide plate are neither locked nor abutted to each other may be used, for example.

(6) In addition to the respective embodiments described above, the arrangement of the LED units with respect to one of the light-entering faces can be changed appropriately.

(7) In addition to the respective embodiments described above, the arrangement of the fixed portions in the outer regions of one of the light-entering faces can be changed appropriately.

(8) In addition to the respective embodiments described above, the configuration, the form, or the like of the exterior members can be changed appropriately.

(9) Although the respective embodiments described above used as an example a liquid crystal display device using a liquid crystal panel as a display panel, the present invention is also applicable to a display device that uses another type of display panel.

(10) In the respective embodiments above, a television receiver that includes a tuner was shown as an example, but the present invention is also applicable to a display device without a tuner.

The embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

TV television receiver
LDU liquid crystal display unit
P power source
T tuner
S stand
LU LED unit
SM screw
10, 110, 210 liquid crystal display device
11, 111, 211 front cabinet
12, 112, 212, 312, 412, 512 rear cabinet
12C, 112C, 212C, 312C, 412C, 512C, 612C fixed portion
12C1, 312C1, 412C1, 512C1, 612C1 screw hole
12D, 112D, 312D, 412D, 512D, 612D locking part
14, 114, 214, 614 liquid crystal panel
16, 116, 216 backlight device
18, 118, 218, 611 frame
19, 119, 219, 619 optical member
20, 120, 220, 320, 420, 520, 620 light guide plate
20A, 120A, 220A, 320A, 420A, 520A, 620A light-entering face
22, 122, 222, 612 chassis
28, 128, 228 LED
212D abutting portion

1. An illumination device, comprising:
a light guide plate having a light-entering face on at least one of opposing end faces thereof and a light-exiting surface on one surface thereof;
a light source arranged selectively along one section of the light-entering face of the light guide plate;
a frame member arranged on a side of the light-exiting surface of the light guide plate, said frame member having a frame-like shape along a periphery of the light guide plate; and
a holding member arranged on a side of the light guide plate opposite to the frame member such that the holding member and the frame member sandwich the light guide plate therebetween,
wherein said holding member has a fixed portion that is disposed facing a section of the light-entering face that does not correspond to said one section where the light source is selectively arranged, said fixed portion being fixed to the frame member.

2. The illumination device according to claim 1, wherein the light guide plate has a quadrangular shape and has the light-entering face on each of the opposing end faces thereof.

3. The illumination device according to claim 2,
wherein the light source is selectively arranged along each of the opposing end faces, and
wherein the light source arranged along one of the opposing end faces is not arranged directly across from the light source arranged-along another of the opposing end faces in a plan view of the light guide plate.

4. The illumination device according to claim 1, further comprising:
a screw that fixes the holding member to the frame member at the fixed portion by penetrating through a screw hole provided in the holding member and penetrating into the frame member,
wherein the holding member has a locking part in an area thereof that is opposite to the light-entering face and that sandwiches the light source therebetween, said locking part locking the holding member to the frame member.

5. The illumination device according to claim 4, wherein said holding member locks to the frame member by engaging with the frame member at the locking part.

6. The illumination device according to claim 1, wherein the holding member has an abutting portion in an area thereof that is opposite to the light-entering face and that sandwiches the light source therebetween, the abutting portion abutting the frame member without being fixed thereto.

7. The illumination device according to claim 1, wherein the frame member and the holding member form an exterior of said illumination device.

8. The illumination device according to claim 1, wherein all the end faces of the light guide plate are said light-entering faces.

9. A display device, comprising:
the illumination device according to claim 1; and
a display panel that performs display using light from said illumination device.

10. The display device according to claim 9, wherein the display panel is a liquid crystal panel that uses liquid crystal.

11. A television receiver device, comprising: the display device according to claim 9.
